(19) United States
(12) Patent Application Publication
(10) Pub. No.: US 2001/0018388 A1
(43) Pub. Date: Aug. 30, 2001

(54) FOLD ROLLER LOCKING ADJUSTMENT MECHANISM FOR A FOLDER

(76) Inventors: JAMES R. MOSER, EASTON, PA (US); MICHAEL R. DRAGO, BETHLEHEM, PA (US); JOHN J. VITKO, EASTON, PA (US); DENNIS KIES, DANIELSVILLE, PA (US)

Correspondence Address: JEFFREY L WILSON, JENKINS & WILSON PA, SUITE 1400 UNIVERSITY TOWER, 3100 TOWER BLVD, DURHAM, NC, 27707

(21) Appl. No.: 09/421,191

(22) Filed: Oct. 19, 1999

(51) Int. Cl. B25F 5/02; F16C 13/00

(52) U.S. Cl. 492/45

(57) ABSTRACT

A fold roller locking adjustment mechanism for a folder, and in particular a buckle folder. The invention eliminates unintended changes to roller gap in a buckle folder by reducing the effect of machine forces on the fold roller support and adjusting mechanism.

### TECHNICAL FIELD

The present invention relates generally to folders. More particularly, the present invention relates to a fold roller locking adjustment mechanism for a folder.

### BACKGROUND ART

Examples of folders and in particular, buckle folders are described in U.S. Pat. Nos. 2,669,331; 3,796,423; 3,797,196; 3,841,621; 4,032,133; 4,099,710; 4,125,254; 4,586,704; 4,781,367; 5,048,809; 5,178,383; 5,269,744; 5,350,170; and 5,797,319 whose contents are hereby incorporated by reference into the instant patent application.

Buckle folders include pairs of opposed fold rollers spaced apart by a gap predetermined by the thickness of the sheet(s) to be fed therebetween and ultimately folded. Rotatable adjusting knobs positioned outside of the folder housing and typically positioned on the top of the folder housing control the position of these fold rollers and the gap between rollers. A description of prior art approaches on how and why the fold roller gap can be set can be found in U.S. Pat. No. 5,350,170 (and patents cited therein), which contents are hereby incorporated by reference into the instant patent application.

Gap size and maintaining a predetermined/pre-selected gap size are critical to the proper operation of a buckle folder. If the gap size is too large, sheet skewing and/or slippage will occur. If the gap size is too small, the sheet(s) will be unable to pass through the gap and the folder will jam. Sheet skewing, slipping, and machine jamming are highly undesirable events that will typically require human operator intervention and machine shutdown while being resolved. Thus, folder productivity is reduced and possible damage to the folder can occur.

Prior art folder designers have attempted to come up with methods that purport to eliminate unintended changes in roller gap size. However, this problem is formidable due to the high stresses and cyclical forces and vibrations produced by a buckle folder as sheet(s) are moved through the various buckle chutes and reverse direction after hitting buckle stop plates. To date, no present solution exists having a high probability of actually eliminating unintended changes in roller gap size as the folder is being operated.

Accordingly, there is room for improvement within the art.

### DISCLOSURE OF THE INVENTION

It is an object of the invention to eliminate unintended changes to the roller gap in a folder.

It is a further object of the invention to eliminate unintended changes to the roller gap in a folder and in particular, a buckle folder.

It is a further object of the invention to eliminate unintended changes to the roller gap in a folder and in particular, a buckle folder by reducing the effect of machine forces on the fold roller support and adjusting mechanism.

These and other objects of the invention are achieved, in whole or in part, by a fold roller locking adjustment mechanism for a folder, comprising: at least one fold roller support and adjusting mechanism, the fold roller support and adjusting mechanism including a vertical fold roller support and adjusting bar having upper and lower ends, the upper end being threaded; a roller rotatably mounted to the lower end of the vertical fold roller support and adjusting bar; an adjusting knob corresponding to each of the at least one fold roller support and adjusting bar, each adjusting knob having: a threaded center hole, the threaded center hole corresponding to the threads of the upper end of the vertical fold roller support and adjusting bar and receiving the threads of the upper end of the vertical fold roller support and adjusting bar; and a fixed vertical position; whereby rotation of the adjusting knob controls the vertical position of the vertical fold roller support and adjusting bar and the roller; and further comprising: a clamp, the clamp locking the threads of the threaded center hole of the adjusting knob to the threads of the upper end of the vertical fold roller support and adjusting bar.

Some of the objects of the invention having been stated hereinabove, other objects will become evident as the description proceeds, when taken in connection with the accompanying drawings as best described hereinbelow.

### BRIEF DESCRIPTION OF THE DRAWINGS

FIG. 1A is an elevation view of a conventional prior art fold roller support and adjusting mechanism for a buckle folder;

FIG. 1B is a detailed sectional view along lines 1B-1B of FIG. 1A;

FIGS. 2A and 2B are simplified elevation views of two prior art attempts for preventing unintended changes to roller positioning in a buckle folder;

FIGS. 3A and 3B are simplified elevation views of the solution according to the invention for eliminating unintended changes to roller positioning in a buckle folder and in the inoperative (FIG. 3A) and operative (FIG. 3B) positions;

FIGS. 4A and 4B are partial magnifications of portions of FIGS. 3A and 3B, respectively; and

FIGS. 5A and 5B are plan and elevation views respectively of an alternative solution according to the invention.

### DETAILED DESCRIPTION OF THE INVENTION

With reference to the above-mentioned figures, a fold roller locking adjustment mechanism for a folder that meets and achieves the objects of the invention set forth above will now be described.

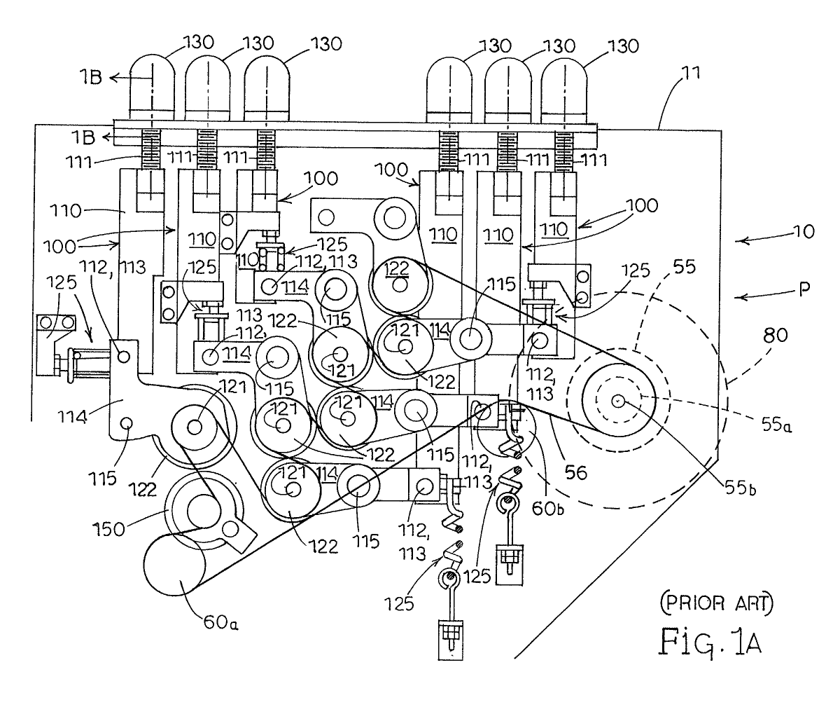

FIG. 1A is an elevation view of a conventional prior art fold roller support and adjusting mechanism for a buckle folder 10 having a top support panel 11.

Buckle folder 10 is provided with a plurality of fold roller support and adjusting mechanisms 100. Each folder roller will be supported at each its ends by one of the plurality of fold roller support and adjusting mechanisms 100 (only one is shown in the drawings herein for simplicity) so that the vertical position of each end of the fold roller can be adjusted. While each fold roller support and adjusting mechanism 100 is slightly different in design due to its position within folder 10, they all have common elements. In particular, each fold roller support and adjusting mechanism 100 includes: vertical fold roller support and adjusting bar 110 having thread portion 111 at its upper end and pivot point 112 at its lower end; pivoting roller support 114 pivotally mounted via axle 113 to pivot point 112 and pivotable about second pivot point 115; fold roller 122 rotatably mounted to pivoting roller support 114 via second axle 111; spring mechanism 125 for biasing vertical fold roller support and adjusting bar 110 in a downward position; and adjustment knobs 130 for adjusting the vertical position of vertical fold roller support and adjusting bar 110, the pivotal position of pivoting roller support 114, and therefore the position of fold roller 122.

To drive folder 10, drive pulley 55 is driven by a drive motor 55a, which may be conventionally positioned on drive shaft 55b or at various other locations based upon the manufacturer of the folder, and feeds drive forces to rollers 122 via belt 56. Take-up idler rollers 60a, 60b prevent belt 56 slack. A stationary exit fold roller 150 is also provided to produce an exit drive couple with the last adjustable fold roller 122. Hand wheel 80 allows a human operator to rotate all the fold rollers 122 at a slow rate and in either direction so that jammed sheets can be removed from folder 10.

Finally, it should be noted that various folder structure not relevant to the instant invention has been left out of FIGS. 1A, 1B for simplicity. Examples of such conventional structure include fold plates and fold deflectors, as can be appreciated by those of skill in the art.

FIG. 1B is a detailed sectional view along lines 1B-1B of FIG. 1A. In particular, FIG. 1B shows that knob 130 has a hollowed out center threaded portion 131 corresponding to threads 111 of the upper end of vertical fold roller support and adjusting bar 110. Knob 130 maintains a fixed vertical position due to top support panel 11 and the downward action of spring mechanism 125 (FIG. 1A). Accordingly, as knob 130 is rotated, depending upon the direction of rotation, the vertical position of vertical fold roller support and adjusting bar 110, the pivotal position of pivoting roller support 114, and therefore the position of fold roller 122 can be controlled.

Conventional folders, such as shown in FIGS. 1A and 1B and listed in the background of the invention above, undergo high stresses and cyclical forces and vibrations produced by the buckle folder as sheet(s) are moved through the various fold plates and reverse direction after hitting the fold plate stop surfaces.

These forces have been found to cause relative movement between knob 130 and threads 111 of the upper portion of vertical fold roller support and adjusting bar 110. This results in unintended movement of the entire fold roller support and adjustment mechanism 100 and hence unintentionally and undesirably changes the roller gap.

As described above, however, gap size and maintaining a predetermined/pre-selected gap size is critical to the proper operation of a buckle folder. If the gap size is too large, sheet skewing and/or slippage will occur. If the gap size is too small, the sheet(s) will be unable to pass through the gap and the folderwill jam. Sheet skewing, slipping, and machine jamming are highly undesirable events that will typically require human operator intervention and machine shut-down while resolved. Thus, folder productivity is reduced and possible damage to the folder can occur.

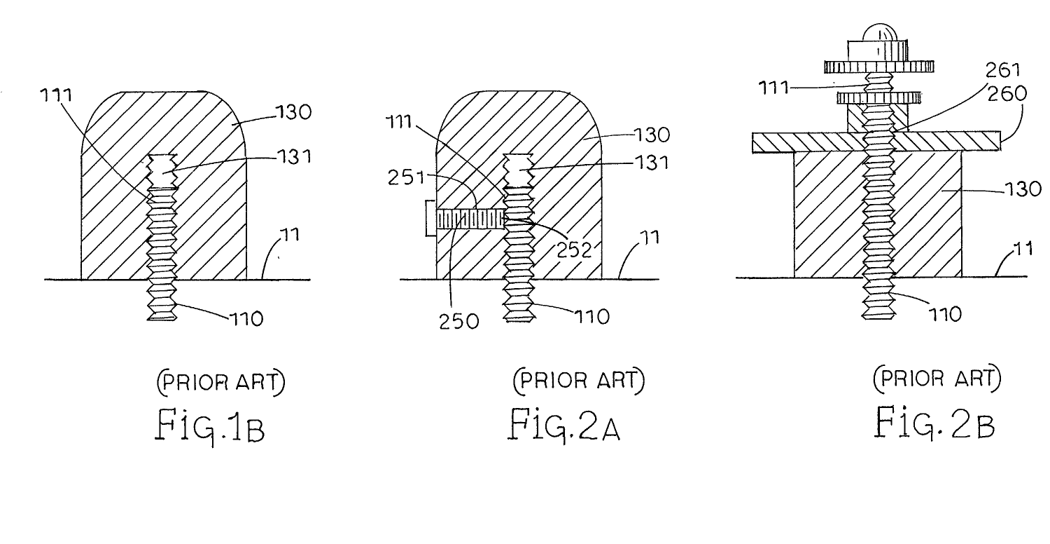

FIGS. 2A and 2B are simplified elevation views of two prior art attempts for preventing unintended changes to roller positioning in a buckle folder.

In FIG. 2A, threaded bore 251 is drilled into the side of knob 130 until it intersects threaded center hole 131 of knob 130. Set screw 250 is then screwed into threaded bore 250 until flat end 252 of set screw 250 comes into contact with threads 111 of vertical fold roller support and adjusting bar 110. In theory, the relative friction forces between flat end 252 of set screw 250 and threads 111 of vertical fold roller support and adjusting bar 110 should be enough to prevent any relative movement between knob 130 and threads 111 and therefore eliminate unintended change in gap size. However, that does not result in practice and even when multiple set screws 250 are used with a single knob 130, the forces resulting from folder operation are enough to cause relative movement between knob 130 and threads 111 and unintended gap size changes.

In FIG. 2B, a second knob 260 having a threaded center bore 261 is provided. Second knob 260 is rotated so as to sandwich knob 130 between second knob 260 and top support panel 11. In theory, such sandwiching of knob 130 should prevent its unwanted or unintended rotation. However, that does not result in practice and again the forces resulting from folder operation are enough to cause relative movement between knob 130 and threads 111 and unintended gap size changes. The locking nut structure shown in U.S. Pat. No. 2,669,331 has the same deficiencies.

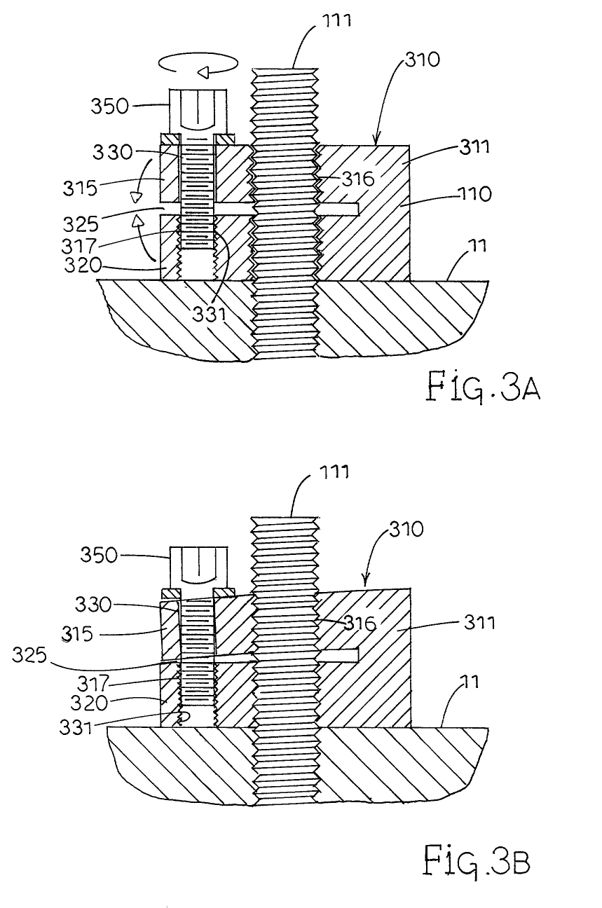

FIG. 3A is a simplified elevation view of the solution according to the invention for eliminating unintended changes to roller positioning in a buckle folder and in an inoperative position.

The solution according to the present invention comprises replacing one or more, but typically all, of the adjusting knobs 130 of the prior art inadequate solutions with a new adjusting knob 310 according to the invention. Each of the adjusting knobs 310 according to the invention has a threaded center hole 316. The threads of threaded center hole 316 correspond to the threads 111 of the upper end of the vertical fold roller support and adjusting mechanism 100 and receive the threads 111 of the upper end of the fold roller support and adjusting mechanism 100. Like in prior art solutions, adjusting knob 310 has a fixed vertical position due to knob 310 being flush with top support panel 11. Accordingly, rotation of adjusting knob 310 controls the vertical position of the fold roller support and adjusting mechanism 100 and roller 120.

Due to the unique construction of knob 310, it further comprises a clamping mechanism for locking the threads of the threaded center hole 316 of adjusting knob 310 to the threads 111 of the vertical fold roller support and adjusting mechanism, as will be described below.

The clamping mechanism comprises a slot 325 formed in the adjusting knob 310. Slot 325 will typically be perpendicular to threaded center hole 316. Slot 325 divides the adjusting knob 310 into an upper tongue portion 315; a lower tongue portion 320; and a connecting portion 311 for connecting the upper 315 and lower 320 tongue portions. Threaded center hole 316 of knob 310 should pass through upper 315 and lower 320 tongue portions.

Upper tongue portion 315 has an upper tongue hole 330 therein and lower tongue portion 320 has a lower tongue hole 331 therein. At least one of the upper 330 or lower 331 tongue holes is threaded and in particular, at least lower tongue hole 331 will have threads 317. Finally, typically, it is foreseen that upper 330 and lower 331 tongue holes will be coaxial and have axes parallel to the axis of threaded center hole 316 of adjusting knob 310.

Clamping member 350, typically in the form of a threaded screw positioned through the upper 330 and lower 331 tongue holes and interacting with threads 317, when turned, urge at least one of the upper 315 and lower tongue portions 320 towards the other. Because threaded center hole 316 of knob 310 will pass through upper 315 and lower 320 tongue portions, as the tongue portions are urged towards each other, the axis of threaded center hole 316 will be distorted, as described below. This configuration is shown in FIG. 3B, which is a simplified and exaggerated elevation view of the solution according to the invention for eliminating unintended changes to roller positioning in a buckle folder and in an operative position.

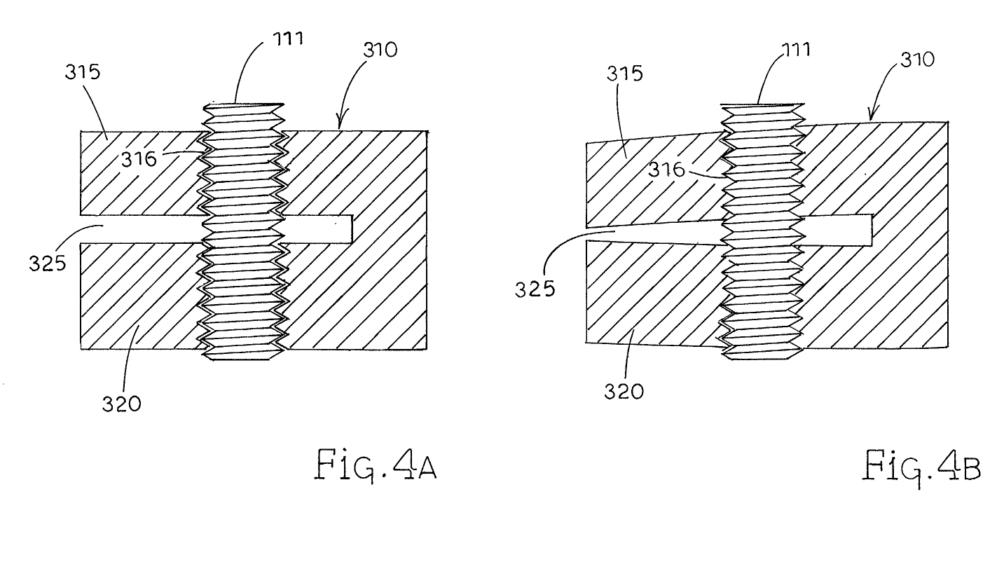

FIGS. 4A and 4B of the drawings are partial magnifications of portions of FIGS. 3A and 3B, respectively. FIG. 4A corresponds to the inoperative position of the clamping mechanism, shown in FIG. 3A. In particular, FIG. 4A shows how the threads 111 of the upper portion of the fold roller support and adjusting mechanism 100 are positioned with respect to the thread of threaded center hole 316 so as to allow the rotation of adjusting knob 310 around threads 111. The positioning comprises a normal thread to thread relationship. This clamping results from the fact that, as described above, threaded center hole 316 passes through upper 315 and lower 320 tongue portions. Accordingly, as the two tongue portions are urged towards each other, the axis of threaded center hole 316 is distorted and the thread-to-thread distance (pitch) reduced. As the threads 111 of the upper end of vertical fold roller support and adjusting bar 100 are positioned between the threads of threaded center hole 316, threads 111 are clamped or sandwiched between the threads of threaded center hole 316. This clamping of threads 111, 316 result in it being virtually impossible for knob 310 to rotate absent forces and stresses even larger than those resulting from the operation of the folder.

FIG. 4B corresponds to the operative position of the clamping mechanism, shown in FIG. 3. In particular, what is shown by FIG. 4B is that the threads 111 of the upper portion of the fold roller support and adjusting mechanism 100 are clamped between the teeth of threaded center hole 316 to prevent the rotation of adjusting knob 310 around threads 111.

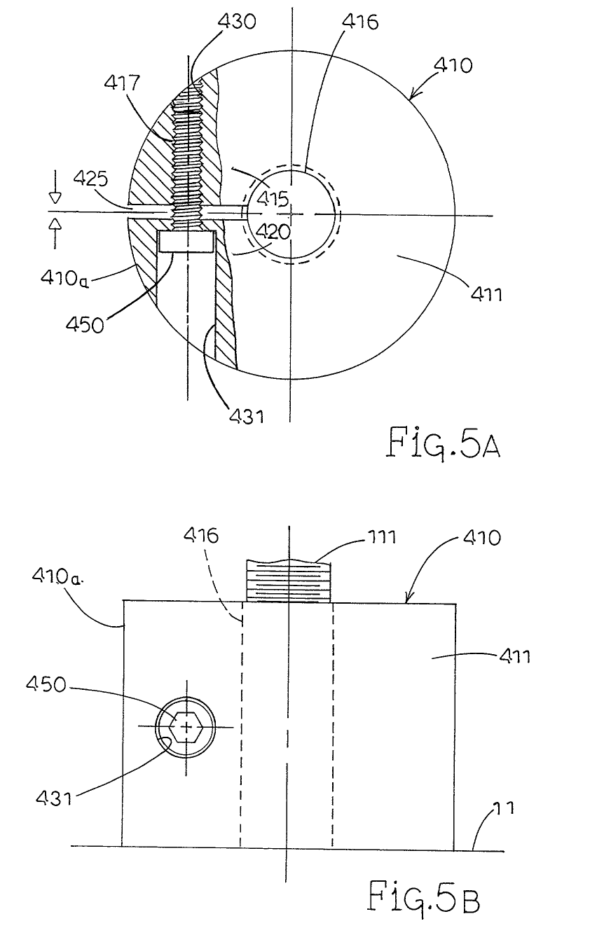

FIGS. 5A and 5B of the drawings are plan and elevation views respectively of an alternative solution according to the present invention. In this alternative embodiment, each of the adjusting knobs 410 according to the invention has a threaded center hole 416. The threads of threaded center hole 416 correspond to threads 111 of the upper end of the vertical fold roller support and adjusting mechanism 100 and receive threads 111 of the upper end of the fold roller support and adjusting mechanism 100. Like in prior art solutions, adjusting knob 410 has a fixed vertical position due to knob 410 being flush with top support panel 11. Accordingly, rotation of adjusting knob 410 controls the vertical position of the fold roller support and adjusting mechanism 100 and roller 120.

Due to the unique construction of knob 410, it further comprises a clamping mechanism for locking the threads of threaded center hole 416 of adjusting knob 410 to threads 111 of the vertical fold roller support and adjusting mechanism 100, as will be described below.

The clamping mechanism for the alternative embodiment comprises a slot 425 formed in the adjusting knob 410. Slot 425 is typically parallel to threaded center hole 416 and spans the width of adjusting knob 410 from its outer circumference 410a to the threaded center hole 416. Additionally, typically slot 425 will span from the bottom of adjusting knob 410 to the top of adjusting knob 410. Slot 425 divides the adjusting knob 410 into a first tongue portion 415, a second tongue portion 420, and a connecting portion 411 for connecting the first 415 and second 420 tongue portions. Threaded center hole 416 is formed by the inner surfaces of first 415, second 420, and connecting 411 tongue portions.

First tongue portion 415 has a first tongue hole 430 therein and second tongue portion 420 has a second tongue hole 431 therein. At least first 430 tongue hole is threaded and has threads 417. Finally, typically, it is foreseen that first and second tongue holes 430, 431 will be coaxial and have axes perpendicular to the axis of threaded center hole 416 of adjusting knob 410.

Clamping member 450, typically in the form of a threaded screw positioned through first 430 and second 431 tongue holes, when turned, urge at least one of first 415 and second tongue portions 420 towards the other. Because threaded center hole 416 of knob 410 is partially defined by slot 425, as first 415 and second 420 tongue portions are urged towards each other in the direction of the arrows shown in FIG. 5A, threaded center hole 416 will be distorted, thereby preventing rotation of knob 410 with respect to threaded shaft 111. However, due to the position of the head of clamping member 450 in this embodiment, the configuration of the embodiment of FIGS. 3 and 4 is preferred. The alternative embodiment is harder to adjust do to the close spacing between knobs 410 on the top support panel 11. The alternative embodiment is also indicative of the fact that multiple configurations beyond those expressly described herein are probably possible to meet the objects of the invention.

Testing and use of adjusting knobs 310, 410 according to the invention has shown that they do prevent unintended and undesirable changes in the roller gap size. It is suggested by the instant inventors that the reason knobs 310, 410 of the invention work to prevent unintended changes in the roller gap size and prior art attempts have failed, is because the instant invention involves the actual deformation of the thread pitch and/or path to prevent the actual rotation of the adjusting knob 310, 410. Prior art attempts at solving this problem have only sought to use some type of additional member to prevent knob rotation but have not actually rendered knob rotation impossible, as has the instant invention.

The above description is given with reference to a locking roller adjustment mechanism for a folder. However, it will be understood that various details of the invention may be changed without departing from the scope of the invention. Furthermore, the foregoing description is for purpose of illustration only, and not for purpose of limitation, as the invention is defined by the following, appended claims.

It will be understood that various details of the invention may be changed without departing from the scope of the invention. Furthermore, the foregoing description is for the purpose of illustration only, and not for the purpose of limitation—the invention being defined by the claims.

What is claimed is:

1. A fold roller locking adjustment mechanism for a folder, comprising:
(a) at least one fold roller support and adjusting mechanism, said fold roller support and adjusting mechanism including a vertical fold roller support and adjusting bar having an upper and lower end, said upper end being threaded;
(b) a roller rotatably mounted to said lower end of said vertical fold roller support and adjusting bar;
(c) an adjusting knob corresponding to each of said at least one fold roller support and adjusting bar, each said adjusting knob having:
(i) a threaded center hole, said threaded center hole corresponding to the threads of said upper end of said vertical fold roller support and adjusting bar and receiving said threads of said upper end of said vertical fold roller support and adjusting bar; and
(ii) a fixed vertical position;
whereby rotation of said adjusting knob controls the vertical position of said vertical fold roller support and adjusting bar and said roller; and
further comprising:
(d) a clamp, said clamp locking the threads of said threaded center hole of said adjusting knob to the threads of said upper end of said vertical fold roller support and adjusting bar.

2. The fold roller locking adjustment mechanism of claim 1, wherein said clamp comprises:
(a) a slot formed in said knob, said slot dividing said knob into:
(i) an upper tongue portion and a lower tongue portion, said threaded center hole passing through said upper tongue portion and said lower tongue portion; and
(ii) a connecting portion for connecting said upper and lower tongue portions; and
(b) a clamping member for urging at least one of said upper and lower tongue portions towards the other.

3. The fold roller locking adjustment mechanism of claim 2, wherein:
(a) said upper tongue portion has an upper tongue hole therein;
(b) said lower tongue portion has a lower tongue hole therein;
(c) at least said lower tongue hole is threaded; and
(d) said clamping member comprises a threaded screw positioned through said upper and lower tongue holes, and interacts with said threads of said lowertongue hole so that when turned, urges at least one of said upper and lower tongue portions towards the other.

4. The fold roller locking adjustment mechanism of claim 3, wherein said upper and lower tongue holes are coaxial.

5. The fold roller locking adjustment mechanism of claim 4, wherein the axes of said upper and lower tongue holes are parallel to the axis of said threaded center hole.

6. The fold roller locking adjustment mechanism of claim 5, wherein said slot is perpendicular to said threaded center hole.

7. The fold roller locking adjustment mechanism of claim 1, wherein said clamp comprises:
(a) a slot formed in said knob, said slot dividing said knob into:
(i) a first tongue portion a second tongue portion, and a connection portion for connecting said first and second portions, said threaded center formed by surfaces of said first, second, and connecting portions; and
(b) a clamping member for urging at least one of said first and second tongue portions towards the other.

8. The fold roller locking adjustment mechanism of claim 7, wherein:
(a) said first tongue portion has a first tongue hole therein;
(b) said second tongue portion has a second tongue hole therein;
(c) at least said first tongue hole is threaded; and
(d) said clamping member comprises a threaded screw positioned through said first and second tongue holes, and interacts with said threads of said first tongue hole so that when turned, urge at least one of said first and second tongue portions towards the other.

9. The fold roller locking adjustment mechanism of claim 8, wherein said first and second tongue holes are coaxial.

10. The fold roller locking adjustment mechanism of claim 9, wherein the axes of said first and second tongue holes are perpendicular to the axis of said threaded center hole.

11. The fold roller locking adjustment mechanism of claim 10, wherein said slot is parallel to said threaded center hole.
